(19) United States
(12) Patent Application Publication
(10) Pub. No.: US 2004/0202352 A1
(43) Pub. Date: Oct. 14, 2004

(54) Enhanced readability with flowed bitmaps

(75) Inventors: Jeffrey A. Jones, Round Rock, TX (US); Scott T. Jones, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/411,469

(22) Filed: Apr. 10, 2003

(51) Int. Cl. G06K 9/00; G06K 9/36

(52) U.S. Cl. 382/114; 382/276

(57) ABSTRACT

A system and method of displaying content on a computer screen, wherein text (or other content) is formatted as multiple bitmaps, for example, each bitmap corresponding to a word. The bitmaps are resized so that they can be easily seen by someone with impaired vision, for example. If the resizing of the text causes some of it to extend beyond the horizontal boundaries of the display, the text is automatically wrapped to the next line.

### BACKGROUND OF THE INVENTION

1. Technical Field

The present invention is directed to a system and method for aiding the visually impaired in reading.

2. Description of Related Art

Many people lack perfect vision. There are many tools and technologies designed to help the visually impaired read displayed text, such as that on a computer screen. Traditional methods include Optical Character Recognition (OCR) and simple scan-and-magnify (SAM) systems.

OCR (optical character recognition) is the recognition of printed or written text characters by a computer. Though there are different methods of implementing OCR, the process generally involves photoscanning of the text or image, analyzing the scanned image, and then translating the character image into character codes, such as ASCII, commonly used in data processing.

In OCR processing, the scanned-in image or bitmap is analyzed for light and dark areas in order to identify each alphabetic letter or numeric digit. When a character is recognized, it is converted into an ASCII code. Special circuit boards and computer chips designed expressly for OCR are used to speed up the recognition process. This recognition process is computationally expensive, since various fonts or scripts can make matching characters difficult, especially if the font is new or a typical

Existing systems for aiding the visually impaired have several disadvantages. In conventional SAM systems, once a page is magnified larger than the final display area, the user must slide the image back and forth to see all of each line, a tedious, hands on and disorienting process. Some tools use formats such as HTML that permit resizing the font and reflowing the page as necessary to fit the display area. However, not all formats allow reflowing, and not all display programs are capable of performing reflowing or allowing resizing by a user. For example, in a typical Internet browser, HTML text can be reflowed. However, if the text displayed on the browser is part of a .gif, .jpg, or .pdf file, for example, the browser is unable to reflow the text.

Furthermore, in OCR systems, problems arise because of poor character recognition and inability to handle diverse fonts and languages.

Therefore, there is a need in the art for an improved system and method of displaying text in electronic media.

### SUMMARY OF THE INVENTION

The present invention creates a tool that takes images (scanned, video captured, screen captured, etc.) and applies several OCR-like functions to them to define and extract bitmaps of text. A bitmap is a general term referring to any representation of a graphics image in computer memory. In one example embodiment, a text page is scanned and mapped. The text on a page is broken into word sized images, and these images are magnified and then reflowed, for example, to fit the display device.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a representation of a computer system consistent with a preferred embodiment.

FIG. 2 shows a block diagram of relevant parts of a computer system capable of implementing the present invention.

FIG. 3 shows a flowchart of the process steps in a preferred embodiment.

FIG. 4A shows a computer screen before implementation of the present invention.

FIG. 4B shows a computer screen displaying magnified text without benefit of the present invention.

FIG. 4C shows a computer screen displaying text consistent with a preferred embodiment of the present invention.

### DETAILED DESCRIPTION OF THE PREFERRED EMBODIMENT

The present innovations are described with reference to the figures. To provide context, a sample computer system is described consistent with implementing a preferred embodiment of the present innovations.

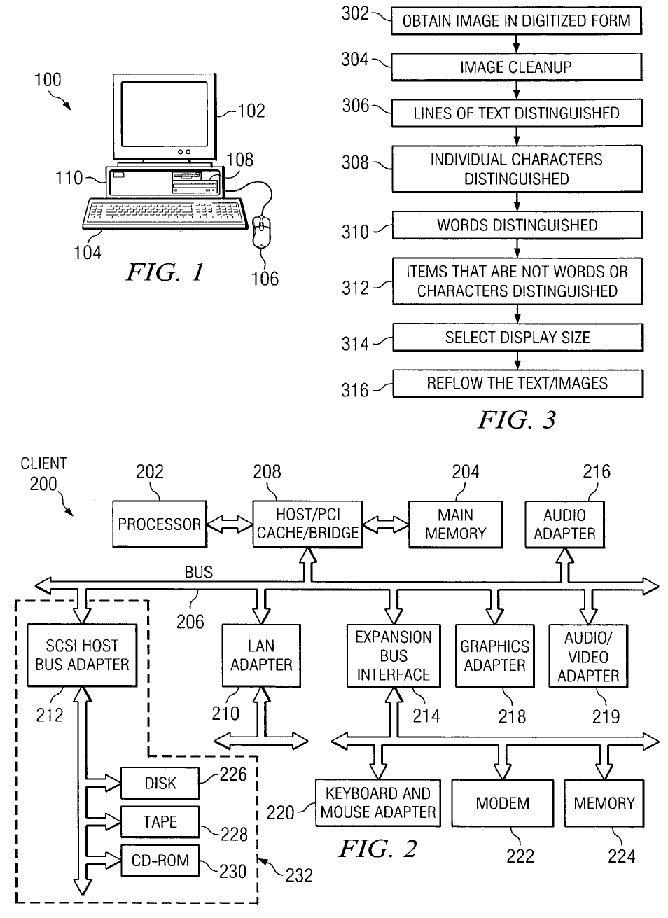

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

In one preferred embodiment, the present innovations are implemented as part of an Internet browser or other program capable of displaying images to a user. FIG. 3 shows a flowchart for implementing the process steps for a preferred embodiment. First, the image or document which the user desires to display is digitized, if it is not already in digitized form (step 302). This step is to create a bitmap of the document or “image.” In this context, the term “image” refers to displayed information, including but not limited to text, graphics or pictures, or a combination of the two. Such a bitmap can be created, for example, by photoscanning of the image or by capturing a screenshot of the image. Alternately, the contents of the file could be rendered to disk. Regardless of the method used, the content to be displayed to the user is captured as a bitmap.

In some embodiments, after a bitmap of the document or image is obtained, some clean up steps are performed (step 304). For example, contrast processing and/or realignment of text may be performed. It should be noted that cleaning up the image is not necessary for practice of the present invention, since individual characters are not necessarily identified as what they are.

Next, in the case of text, the different lines of text are distinguished by the program (step 306). Individual characters are then distinguished (though preferably not identified, i.e., OCR is not yet applied) (step 308). (It should be noted that the term “distinguish” as used herein refers to merely telling where one item ends and another begins, or telling where the boundary of one object or character or word ends and another's begins, while the term “identify” is meant to refer to actual identification of a character, i.e., matching it to a known character. Hence, lines of text and words and even characters may be “distinguished” but not “identified.” If a word were distinguished but not identified, the beginning and end of the word would be known, but not the meaning or spelling or other content of the word.)

After characters are distinguished, groupings of characters that form words are distinguished (step 310). Once words are distinguished, items that are neither words nor characters are distinguished, such as graphics images (step 312). Note that individual characters need not be matched or identified in the preceding steps. Note also that the innovative system could also simply seek out spaces consistent with spacing between words to distinguish individual words, or to define “word areas,” or areas of the document corresponding to a single word, or even groups of words.

After individual words have been distinguished, the preferred display size of the content is indicated, preferably by a user of the innovative system (step 314). This can be implemented in many ways. For example, in a browser display, the individual words can be formatted as image files such as gif or .jpg. These image files can be resized by a browser by using HTML image tags. For example, a typical image tag can include a note indicating the display size:

<img src=word001.gif width=50>

In this example, the individual word has been made into a .gif file named “word001.gif.” The displayed width of this individual image is indicated by the tag “width=50” which means the image (i.e., the word) will be 50 pixels wide.

Consistent with this example implementation, the size of the individual word image “word001.gif” can be enlarged by altering the “width” tag to a larger number.

Alternately, the images could be magnified before they are broken into individual images. For example, the image of each word could be enlarged using known software that expands an image. The enlarged individual word images can then be arranged on the page to fit the width of the viewable are of the display.

Some images are scanned at higher resolution than that at which they are displayed. Such an image could be subdivided into words and those individual words, instead of being magnified, would be demagnified before being displayed, or could be displayed at their original size if appropriate. Another alternative includes magnifying the entire image to the desired magnification before parsing it into individual words, then parsing and reflowing the document at the preferred magnification.

After magnification, the image is reflowed (step 316) according to the preferred display size and the available display area. This step preferably comprises situating the individual images/words into lines of text such that a single line of text spans no more than the available display area. Reflowing is preferably done at the level of individual words, which were distinguished previously in the process. The words are preferably reflowed according to their new size such that the text only spans the available display area and does not go beyond. Hence, after resizing and reflowing, a line of text would begin at one side of the display area, and when the words displayed on that line reach the other side of the display area, the next word is wrapped to the next line automatically. This prevents the user from having to scroll across to read the entire line of text.

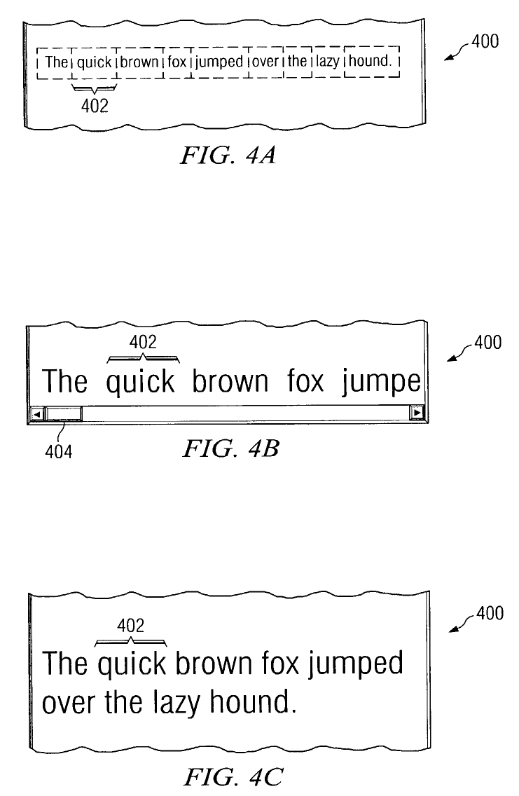

FIGS. 4A-C show potential arrangements for text on a page. In FIG. 4A, the sentence is in a small font, and the entire sentence fits the viewable display area 400. In a preferred embodiment, the sentence is parsed and each word 402 is separated and made into an individual bitmap. Any format for the bitmap is consistent with the present innovations.

In FIG. 4B the text has been enlarged according to typical OCR or SAM systems. The sentence runs off the viewable display area 400 so that a user who wishes to view all the text must use the scroll bar 404 to scan the entire page width.

In FIG. 4C the present innovations are employed. The individual words 402 have been arranged so they wrap to the next line when there is no more viewable area 400 to the display.

One embodiment of the present innovations is implemented as part of a browser program. The innovative aspects can be implemented as part of the browser program itself, or as a separate program working in combination with the browser program. In either case, the text or images displayed by the browser can be resized and reflowed according to the commands of the user. Reflowing is implemented (in this example) by creating graphics images of the individual words (for example, as described in the process of FIG. 3), and reflowing the images using autogenerated HTML coding and the “width” tag.

The present innovative concepts can also be implemented as a stand-alone computer program capable of working in combination with a non-browser program, such as Adobe's Acrobat Reader™, for example.

It should be noted that the present invention avoids many of the disadvantages of existing OCR systems. First, the text of a page can be displayed in enlarged or magnified form while the words are wrapped to the area available for display. The present innovations also avoid the need for converting an image imperfectly into text and then converting the text back into magnified characters. The present invention also allows virtually any printed document to be viewable as a single top-to-bottom document of any size, with words wrapped to the width of whatever area is available for display.

Another advantage of the present invention stems from the fact that at no point is the individual character matched to a particular known character. For example, in OCR systems, when the program detects the image of an individual letter, the image must be compared to known letters until a match is found. This complicates OCR systems and makes them less effective for recognizing text of documents in new or unknown fonts or languages. The present invention, since it only parses the text into words but need not necessarily recognize the individual characters of the words, can be used to enlarge the displayed text of various language.

The present invention can therefore be used to reflow languages of different fonts or scripts, languages not amenable to character recognition (such as handwritten text or script), and languages with different primary and secondary directions. In the context of the present invention, the primary direction of text flow in an English language document would be left to right. The secondary direction would be from top to bottom. In other languages, the primary flow direction may be right to left (as in some Arabic writing) or top to bottom (as in Japanese writing). Secondary directions can change as well, and are not limited by the present inventive concept. The present invention can also be used to enlarge and reposition non-text symbols or pictures.

Likewise, the primary boundaries of an English text document are the left and right margins, while the secondary boundaries are the top and bottom margins, corresponding to the primary and secondary directions described above.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for displaying text in a viewable area of a display device, comprising the steps of:
determining breaks between words of the text;
creating individual bitmaps of at least some of the individual words;
displaying the bitmaps within the primary boundaries of the viewable area of the display device.

2. The method of claim 1, wherein the bitmaps are enlarged before they are displayed.

3. The method of claim 1, wherein the bitmaps are reduced in size before they are displayed.

4. The method of claim 1, wherein the step of displaying the bitmaps within the primary boundaries of the viewable area of the display device is performed by wrapping some of the bitmaps to a new line when the width of the displayed bitmaps would be greater than the width of the viewable area of the display device.

5. The method of claim 1, wherein the primary boundaries are the left and right edges of the viewable display area.

6. A method of displaying information on a display device, comprising the steps of:
defining and extracting a plurality of bitmaps from a document;
controlling magnification of the bitmaps; and
reflowing the bitmaps.

7. The method of claim 6, wherein at least some of the bitmaps comprise individual words of text.

8. The method of claim 6, wherein at least some of the bitmaps comprise symbols.

9. The method of claim 6, wherein the magnification of the bitmaps is controlled by a user.

10. The method of claim 6, wherein the magnification of the bitmaps is stored as a user preference.

11. The method of claim 6, wherein the bitmaps are reflowed such that no bitmaps extend beyond primary boundaries of the display device.

12. A system for displaying content, comprising:
a display device having a viewable display area, the viewable area having left and right boundaries;
a document including displayable information;
wherein individual parts of the displayable information are formatted as bitmaps; and
wherein the individual parts are reflowed within primary boundaries of the viewable area.

13. The system of claim 12, wherein the bitmaps are resized according to a user input.

14. The system of claim 12, wherein the bitmaps are resized according to a stored value.

15. The system of claim 12, wherein the displayable information is text.

16. A system for displaying text, comprising:
means for determining breaks between words of the text;
means for creating individual bitmaps of at least some of the individual words;
means for displaying the bitmaps within the primary boundaries of the viewable area of the display device.

17. The system of claim 16, wherein displaying the bitmaps within the primary boundaries of the viewable area of the display device is performed by wrapping some of the bitmaps to a new line when the width of the displayed bitmaps would be greater than the width of the viewable area of the display device.

18. The system of claim 16, wherein the primary boundaries are the left and right edges of the viewable display area.

19. A method of displaying content on a display device, comprising the steps of:
formatting the content as a plurality of bitmaps;
resizing the bitmaps of the plurality;
reflowing the bitmaps of the plurality such that no content extends beyond the primary boundary of a viewable area on the display device.

20. The method of claim 19, wherein each bitmap of the plurality is an individual word.

21. The method of claim 19, wherein the bitmaps are resized by manipulating HTML tags associated with the bitmaps.

22. The method of claim 19, wherein the content comprises text.

23. A system for magnifying text on a display device, comprising the steps of:
means for reformatting the text as a plurality of bitmaps;
means for reflowing the bitmaps.

24. The system of claim 23, wherein the bitmaps are enlarged before they are reflowed.

25. The system of claim 24, wherein the bitmaps are enlarged according to a user input.

26. The system of claim 23, wherein individual words of the text are formatted as individual bitmaps.

27. The system of claim 23, wherein the bitmaps are reflowed to fit within primary boundaries of the display device.

28. A method of displaying content on a display device, comprising the steps of:
formatting the content as a plurality of bitmaps;
responsive to a user input, resizing the bitmaps of the plurality;
reflowing the bitmaps of the plurality based on a width of the display device and size of the bitmaps of the plurality after the step of resizing.

29. The method of claim 28, wherein the bitmaps of the plurality are resized such that no content extends beyond a primary boundary of a viewable area on the display device.

30. The method of claim 28, wherein the bitmaps of the plurality are resized by manipulating HTML tags associated with the plurality of bitmaps.

31. A system for displaying content on a display device, comprising:
a document having displayable content, wherein the displayable content is formatted as a plurality of bitmaps;
means for resizing the bitmaps of the plurality responsive to user input;
wherein the bitmaps of the plurality are reflowed based on a width of the display device and size of the bitmaps of the plurality after the bitmaps of the plurality are resized.

32. The system of claim 31, wherein the bitmaps of the plurality are resized such that no content extends beyond a primary boundary of a viewable area on the display device.

33. A computer program product for displaying content on a display device, comprising:
first instructions for formatting the content as a plurality of bitmaps;
second instructions for resizing the bitmaps of the plurality responsive to a user input;
third instructions for reflowing the bitmaps of the plurality based on a width of the display device and size of the bitmaps of the plurality after the step of resizing.

34. The computer program product of claim 33, wherein the bitmaps of the plurality are resized such that no content extends beyond a primary boundary of a viewable area on the display device.
